(19) United States
(12) Patent Application Publication
(10) Pub. No.: US 2009/0050266 A1
(43) Pub. Date: Feb. 26, 2009

(54) CROSSLINKED POLYMERIC MATERIALS AS FILLER AND SPACERS IN ADHESIVES

(76) Inventor: Kang Yang, San Diego, CA (US)

Correspondence Address: LAW OFFICE OF MARK WISNOSKY, 3060 6TH AVE., # 8, SAN DIEGO, CA, 92103, US

(21) Appl. No.: 11/842,587

(22) Filed: Aug. 21, 2007

(51) Int. Cl. C09J 5/06

(52) U.S. Cl. 156/307.3; 525/55

(57) ABSTRACT

A new adhesive system is presented. It has been discovered that crosslinked polymeric materials may be used both as spacer particles and as filler in adhesives. The adhesives are especially useful for attaching electronic devices where controlled adhesive bond width is required and the devices make use of lead free solder or otherwise require high temperature processing. New methods for selection of suitable material to be used as spacer and filler material are presented.

### TECHNICAL FIELD

Embodiments of the invention relate to adhesives used in the electronics industry for die attach and other purposes.

### BACKGROUND OF THE INVENTION

Adhesives have many uses in electronic manufacturing. Some of the most common in modern devices is the attachment of chips to printed circuit boards, the attachment of chips to other packages and the attachment of these packages to printed circuit boards. The demands of cost, electrical performance and manufacturability have driven the development of more exotic adhesives. Adding filler to adhesives is well known. Inorganic and organic polymeric fillers have been added to adhesives for a variety of reasons. Calcium carbonate has been added to reduce cost, silica has been added to reduce the coefficient of thermal expansion, metallic fillers have been added for electrical properties and nitrides have been added to reduce thermal conductivity. Development of fillers for modification of properties is still an area of active research. In addition to the properties of cost, thermal expansion and thermal conductivity, higher clock speed electronics and new manufacturing techniques have required control of the rheological properties of resins. It has been found that fillers can help control these properties as well. Recently fillers have been used as spacer particles as well. Controlling the width of the adhesive layer is important for the reliability and performance of the mounted or manufactured device. Use of inorganic and organic spherical particles have been found to provide a simple means of controlling the thickness without the need for exotic jigging devices. The electronics manufacturers are now replacing lead based solder with lead free solder.

The processing temperatures required of lead free solder are typically 30 to 50 degrees Celsius higher than that required for lead based solder. Processing at 260° C. requires filler and spacer particles that can withstand this higher temperature. Particles that decompose at this higher processing temperature can result in delamination and breakdown of the adhesive bond. New materials are required that continue to provide the controlled rheological, electrical, reliability and other properties of past fillers, that can be used as spacer particles and that can withstand the new higher temperature processing without decomposition, voiding, delamination or otherwise breaking down. Previous patent and technical literature has taught that the use of a spacer or filler particle that is crosslinked thus providing a glass transition temperature (Tg) higher than the curing temperature of the resin will result in void formation and delamination. New materials are required that overcome this deficiency.

### SUMMARY OF THE INVENTION

The use cross-linked polystyrene and polymethylmethacrylate beads as both filler and spacer particles in a variety of resin systems have been found to provide a new adhesive system with surprisingly good performance. Even though these new fillers are crosslinked and have a Tg higher than the curing and processing temperature of the resins, the resultant adhesive joints have been found to be void free and perform reliably. The materials provide an UV or heat curable resin based adhesive system with controlled rheological properties for application, controlled bond line thickness, a hydrophobic bond layer with low dielectric constant, and reliability even at processing temperatures required of lead-free solders.

Other embodiments of the invention include the process of using these material combinations to provide an adhesive joint for electronic packaging. Non-limiting examples of uses are to join silicon to silicon, silicon to printed circuit boards, silicon to flex circuit substrates or any number of combinations of substrates currently or anticipated to be used in the electronics industry. Another embodiment provides the assembled microelectronic device comprising an adhesive joint itself comprising an adhesive with cross-linked polystyrene and/or polymethylmethacrylate beads as either or both filler and spacer particles and a variety of resin systems. Another embodiment uses crushed or ground cross-linked material as a filler either alone or in conjunction with cross-linked beads as spacer material.

### BRIEF DESCRIPTION OF THE DRAWINGS

FIG. 1 is a schematic representation of an electronic device attached to a substrate. The drawing is not to scale.

FIG. 2 is an additional view of the device depicted in FIG. 1. The drawing is not to scale.

FIG. 3 is a thermogravimetric analysis curve for uncrosslinked polystyrene beads.

FIG. 4 is a thermogravimetric analysis curve for crosslinked polystyrene divinylbenzene beads.

FIG. 5 is a thermogravimetric Analysis for uncrosslinked Polymethylmethacrylate beads.

FIG. 6 is a thermogravimetric analysis for crosslinked polymethylmethacrylate ethylenedimethacrylate beads.

FIG. 7 is a high temperature test of an adhesive with crosslinked beads.

### DETAILED DESCRIPTION

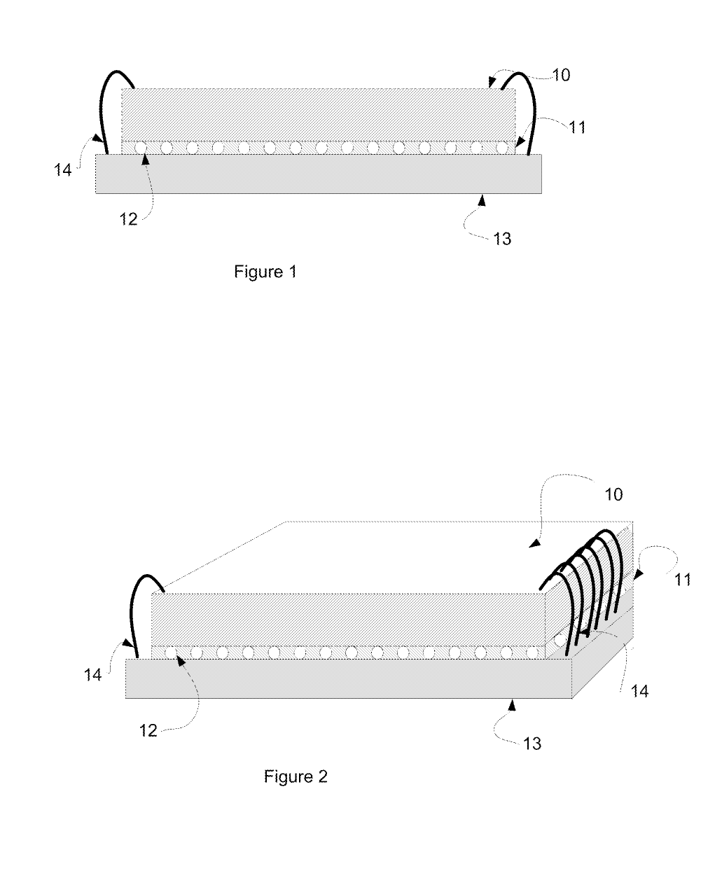

Embodiments of the invention provide filler and spacer material for use in adhesive compositions for the electronics industry, adhesive compositions making use of the spacer and filler material, processes for the use of the adhesive compositions and devices manufactured making use of the compositions and processes. FIGS. 1 and 2 provide two schematic views of a device manufactured using the inventive compositions and processes. A device 10 is adhesively bonded to a substrate 13 by means of an adhesive layer 11. In one embodiment the adhesive layer further comprises spacer particles 12 the size of which define the thickness of the adhesive bonding layer 11. The device 10 is electrically connected to the substrate 13 through wire bonding 14. The device, adhesive and substrate of the Figures are intended as schematics. Non-limiting examples of devices include devices made of silicon, gallium arsenide quartz, sapphire and the like. In one embodiment the substrate 13 is a lead frame, pin grid array, ceramic, printed circuit board, flexible tab circuit or the like. In another embodiment the substrate 13 is another microelectronic device producing a stacked device construction. In another embodiment multiple microelectronic devices may be stacked to create a structure. In another embodiment the connections 14 between bonded structures is through tape automated bonding (TAB). In yet another embodiment the bonding elements are surface mount pads, solder bumps, or the like. As recognized by those skilled in the art the compositions and processes of the present invention can be employed for manufacture of a variety of structures not limited by the examples presented here for illustration.

Spacer particles for use in the present invention are substantially spherical and typically have a mean particle size of 0.5 microns to 1000 microns, preferably in the range of 2 to 200 microns. The thickness of the adhesive layer is determined by the particle size. Widths may be tailored to the physical and electrical requirements of the constructed electronic package. Exemplary physical requirements include lengths or sizes of the electrical bonding elements 14, and electrical performance requirements based upon impedance of proximal circuitry on bonded layers and the dielectric constant of the adhesive layer. An embodiment of the invention allows custom device design and optimization through the selection of the adhesive layer thickness by spacer particle size and selection of the dielectric constant of the adhesive through selection of materials, including adhesive resin, filler particles and spacer particle composition. Spacer particles are typically used in the range of 0.1 weight % to 25 wt % optimally in the range of 0.1 to 5 wt %.

In one embodiment the polymeric filler particles for use in the present invention are substantially spherical and typically have a mean particle size of 0.1 microns to 500 microns, preferably in the range of 0.1 to 15 microns. The filler particles are selected on the basis of stability and desired rheological properties of the uncured adhesive and for the thermal stability, dielectric constant and other properties of the cured adhesive layer. Other fillers including a range of inorganic fillers are known in the industry, examples of such fillers were discussed in the background material. Embodiments of the invention include use of such already known fillers with the polymeric fillers that are the subject of the present invention. The polymeric fillers that are the subject of this invention are uniquely selected based upon compatibility with uncured resin components, desired performance characteristics of the uncured resin including rheological properties and dispersion stability characteristics and the required performance characteristics of the cure adhesive layer. Such properties include hydrophobicity, dielectric constant, thermal, mechanical and thermomechanical behavior of the cured adhesive. Larger beads are typically used for spacer particles and smaller beads are typically used as filler particles. In another embodiment the a bimodal size distribution of beads is used, thus providing both crosslinked polymeric filler and spacers in the same adhesive.

In another embodiment the particles used for fillers are composed of ground particulate of the filler material. The ground filler material is composed of fractured, random shaped particulate typically in a size of 0.1 to 500 microns, preferably in the range of 0.1 to 15 microns.

In another embodiment ground particulate is used for the filler material and substantially spherical particles are used for spacer material. The filler material may be, but is not required to be of the same polymeric composition as the spacer bead material.

An embodiment of the present invention includes newly discovered compatibility characteristics of the uncured resin that have enabled use of new polymeric filler and spacer materials. Use of polytetrafluoroethylene (PTFE) as a filler to produce a thixotropic adhesive mixture has been discovered to stabilize the dispersions of polymethylmethacrylate polymeric filler and spacer particles. Without such dispersion stabilizers the PMMA filler and/or spacer was found to create an unstable dispersion. Instability with respect to dispersability is here defined as a tendency for the particles to settle out and separate from the remaining components of the uncured adhesive mixture. Organic polymers from which the spacers and filler particles are selected are substantially crosslinked. It is known by those skilled in the art that Crosslinked polymers refer to polymers in which the individual polymer chains are bonded to form a networked structure through either covalent bonds or hydrogen bonding.

Exemplary polymethylmethacrylates contemplated for use in the practice of the present invention include compounds having structure I as follows:

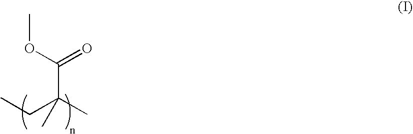

wherein n is an integer ranging from 100 to 10,000 resulting in linear uncrosslinked polymers with a molecular weight in the range of 10,000 to 1,000,000.

Exemplary crosslinking agents added to structure I include ethylene dimethacrylate II

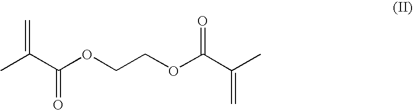

and acrylic acid III

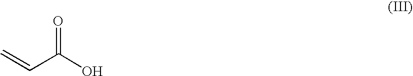

Both are known in the art to produce crosslinked structures with PMMA I. Embodiments using agents exemplified by acrylic acid result in crosslinking through hydrogen bonding. Embodiments utilizing structures exemplified by ethylene dimethacrylate II produce structures with true covalently bonded crosslinked structures of polymethylmethacrylate I. Both types of structures are exemplary crosslinked polymeric structures used in the practice of the present invention. Other mono- and multi-functional crosslinking agents are known to those skilled in the arts and are used in the practice of the present invention.

Exemplary polystyrene bead material for both filler and spacer embodiments of the present invention have a structure IV:

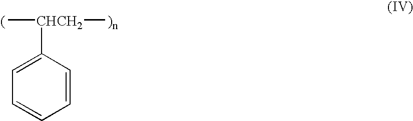

Crosslinking of the polystyrene structure IV can be accomplished by various multifunctional agents. An exemplary structure is divinylbenzene V:

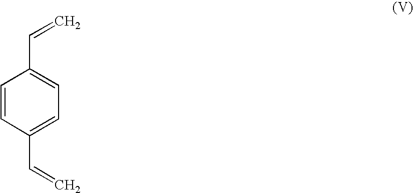

Which produces structures with a linear formulation VI:

[CH₂CH(C₆H₅)]ₓ[CH₂CH[C₆H₄(CHCH₂)]]_{y} (VI)

In an embodiment spacer particles, suitability for use as a filler or spacer is dependent upon the material properties of the spacer or filler particles themselves, interaction properties such as solubility and dispersability of the filler or spacer material with other components and the properties of the resultant uncured adhesive such as rheological properties compatible with the application method and properties of the fully cured adhesive such as thermal stability, dielectric constant and thermal expansion properties.

The adhesive compositions are comprised of materials selected from monomeric and polymeric resins, the crosslinked polymeric fillers and/or spacer materials of the present invention, other filler and/or spacer materials, including uncrosslinked filler material to control the modulus of the cured adhesive, coupling agents, anti-oxidants, stabilizers, bleed control agents, inert diluents, reactive diluents, adhesion promoters, dyes, pigments, and curing catalysts and other materials known in the art. Resins for use in the present invention include maleimides, acrylates, vinyl ethers, vinyl esters, urethanes, polyesters, polyester-linked methacrylates, styrenic compounds, epoxies, silane modified epoxies, amine modified epoxies, silicones, liquid rubber, allyl functional compounds and mixtures of two or more thereof. Other filler and/or spacer material include inorganic material such as aluminum nitride, boron nitride, alumina, silicon dioxide and uncrosslinked organic material like perfluorinated hydrocarbons, polyalkylsilsesquioxane, uncrosslinked polymers such as acrylates, alpha-olefins, vinyl esters, acrylamides, acrylonitriles, maleimides, urethanes and the like known in the art. The present invention now further includes cross-linked filler and/or spacer material not previously anticipated in the art.

Exemplary acrylate polymerizable monomers for use in the present invention include: Isobornyl methacrylate VII,

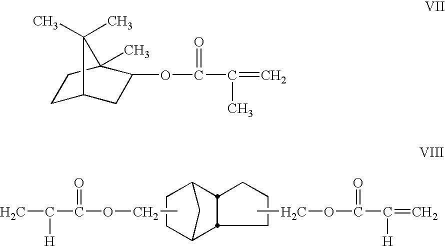

and, Trimethylolpropane trimethacrylate IX.

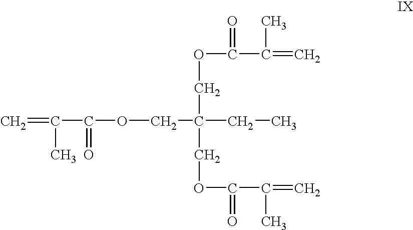

Exemplary maleimide polymerizable monomer materials includes N-cyclohexyl maleimide X, and

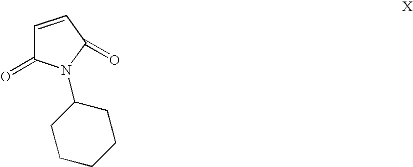

straight or branched alkyl maleimide XI,

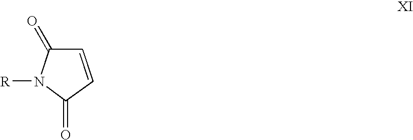

where the R group is a straight or branched alkyl group of 1 to 10 carbons.

Exemplary polymeric resin components include: Polybutadiene dimethacrylate and polybutadiene adducted with maleic anhydride, maleimide containing resins XII, urethanes XIII, and polyacrylates XIV.

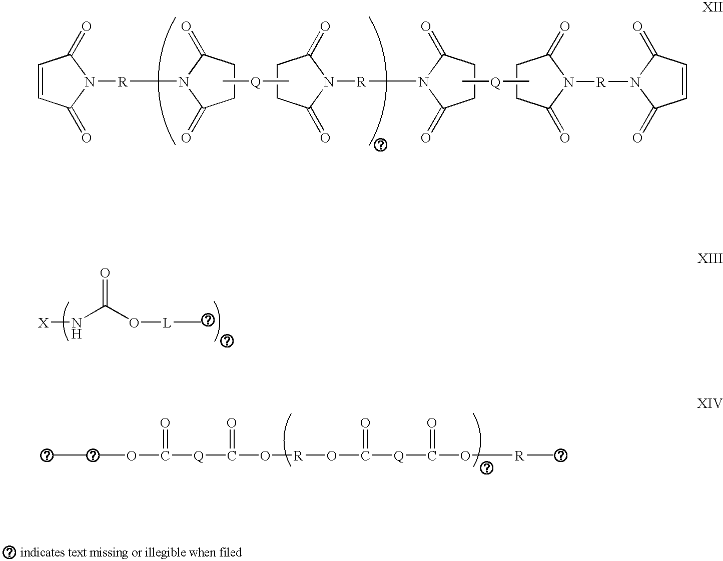

Exemplary maleimides include structure XII wherein R and Q are each, independently, a substituted or unsubstituted aliphatic, aromatic, heteroaromatic or siloxane and n is 1 to about 10. Exemplary urethanes include structure XIII, wherein X, L and E are independently selected, and X is a substituted or unsubstituted aliphatic, aryl or heterocyclic, E is a polymerizable group such as an acrylate, olefin, epoxy, maleimide, vinyl ether, vinyl ester, and L is either a bond or a linking moiety, and the like, known to those skilled in the art. Exemplary polyacrylates include structure XIV wherein R and Q are, independently, aliphatic, aryl or heteroaryl moieties. Exemplary thermoplastic includes styrene/butadiene resins, butadiene dimethacrylate copolymers and polybutadiene maleic anhydride adducts all of which are selected such that they dissolve within the other resin components.

Exemplary coupling agents include 3,4-epoxycyclohexylethyltrimethoxy silane and methacryloxypropyltrimethoxysilane, commercially known as A 186 and A 174 respectively. Selection of the catalyst is dependent upon the resin system being employed. In one embodiment utilizing monomer and/or polymeric acrylates, a peroxide initiator such as Perkadox 16 or Trigonox 141 available from Akzo Nobel. Another embodiment including resins which cure by a cationic or anionic polymerization mechanism, include cationic catalysts or transition metal catalysts. Exemplary transition metal catalysts include nickel cobalt and copper. Exemplary cationic catalysts include onium salts, iodonium salts and the like.

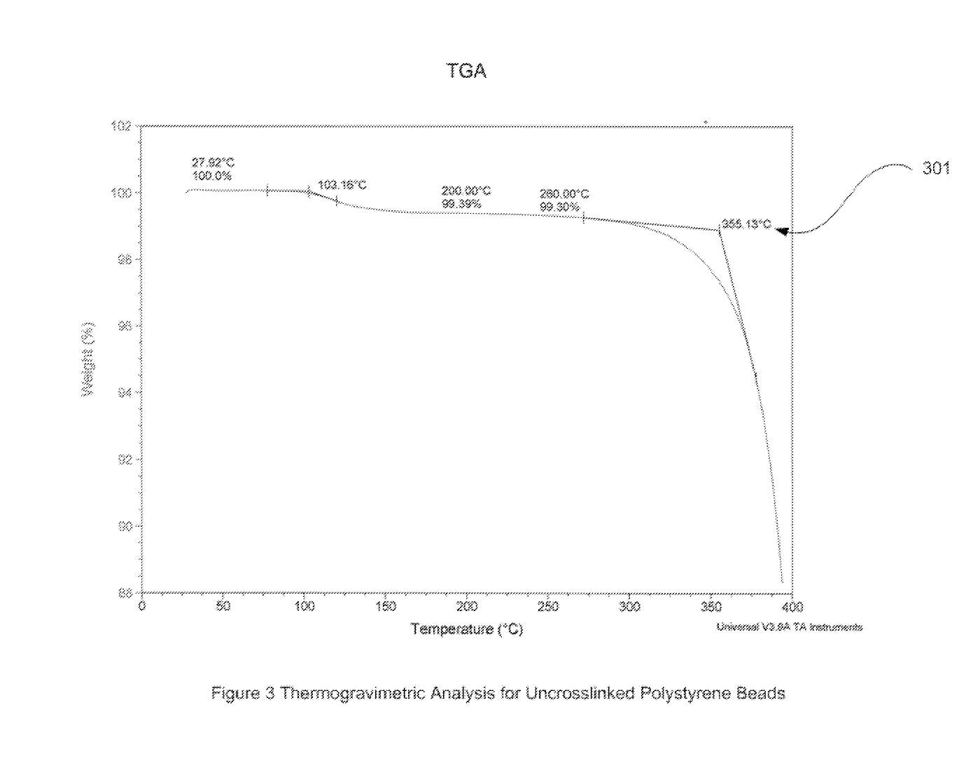

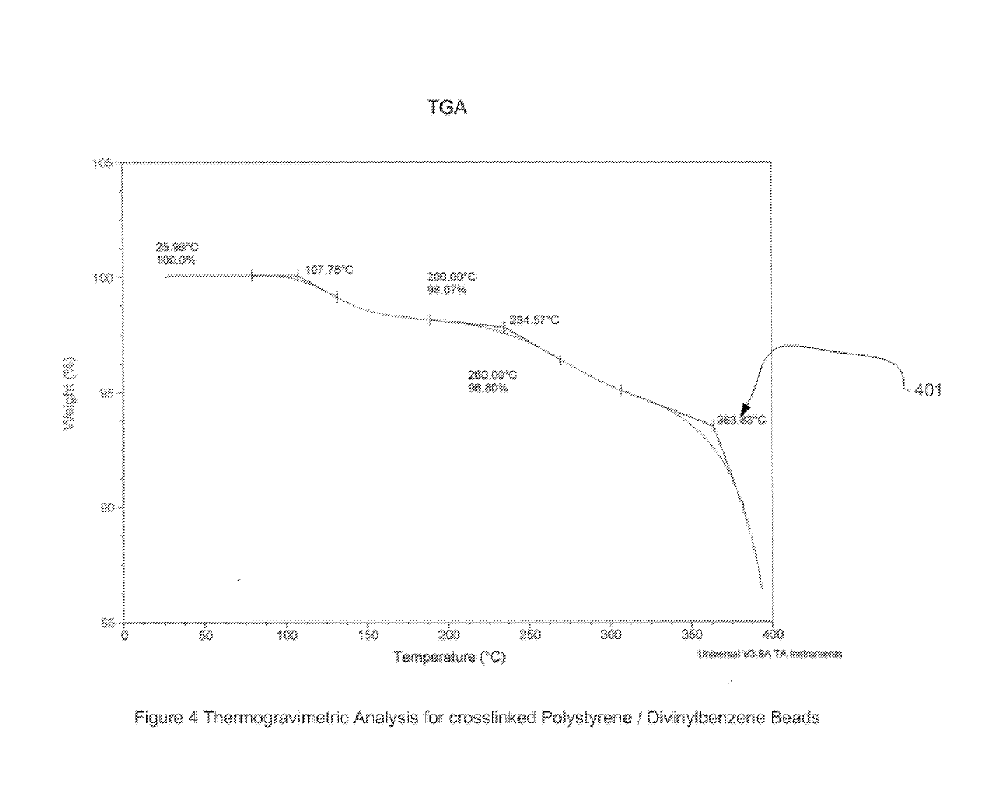

Embodiments use thermal and solubility parameters for selection of suitable filler and spacer bead materials. Embodiments of the invention use properties of the beads to determine a priori suitability for adhesive applications. Thermogravimetric Analysis (TGA) is a technique known in the art for assessing thermal stability of polymeric and other materials. Milligram quantity samples are placed in a heating chamber whose weight may be monitored as the temperature of the chamber and sample is increased. Analysis may be done in an inert, for example nitrogen atmosphere as was done in the examples shown here. FIGS. 3 through 6 show thermogravimetric analysis results for exemplary beads some of which are found suitable for use as high temperature fillers and some of which are not. The vertical axis represents the % of the initial sample weight retained as the sample is heated. The horizontal axis indicates the temperature of the sample. FIG. 3 shows a thermogravimetric analysis for uncrosslinked polystyrene beads. The results show small weight loss up to and past 260 C. This is the temperature typically required for reflow of lead-free solder. Small changes in the weight may be due to moisture or other volatile components loss from the samples. Decomposition is seen to take place at about 355 C. (301) identified by the inflection in the curve indicating significant weight loss at this temperature and above. The results indicate the sample would not be suitable for use at temperatures above this point due to thermal decomposition. However stability up to this point indicates based upon thermogravimetric analysis alone the uncrosslinked polystyrene beads would be suitable for use as filler and spacer material in resins requiring reflow temperatures up to approximately 260 C. Other parameter requirements such as solubility are discussed below. In another embodiment, crosslinked Polystyrene divinylbenzene beads are subjected to a similar analysis. FIG. 4 is Thermogravimetric analysis curve for the polystyrene divinylbenzene beads. Again these beads are seen to be thermally stable up to approximately 360 C. (401).

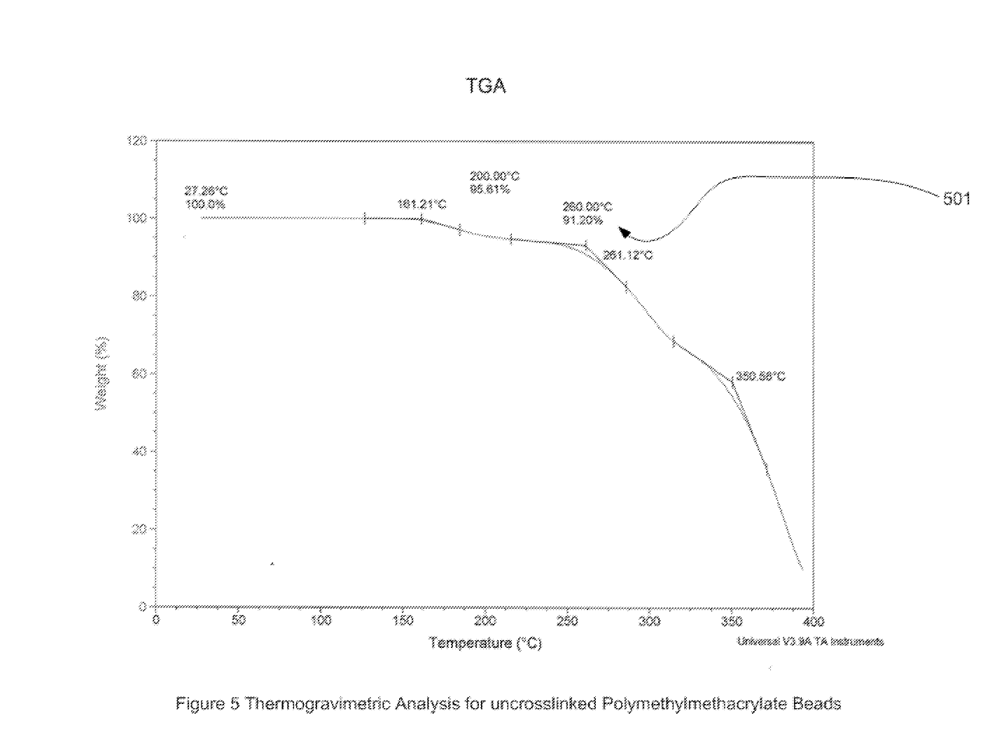

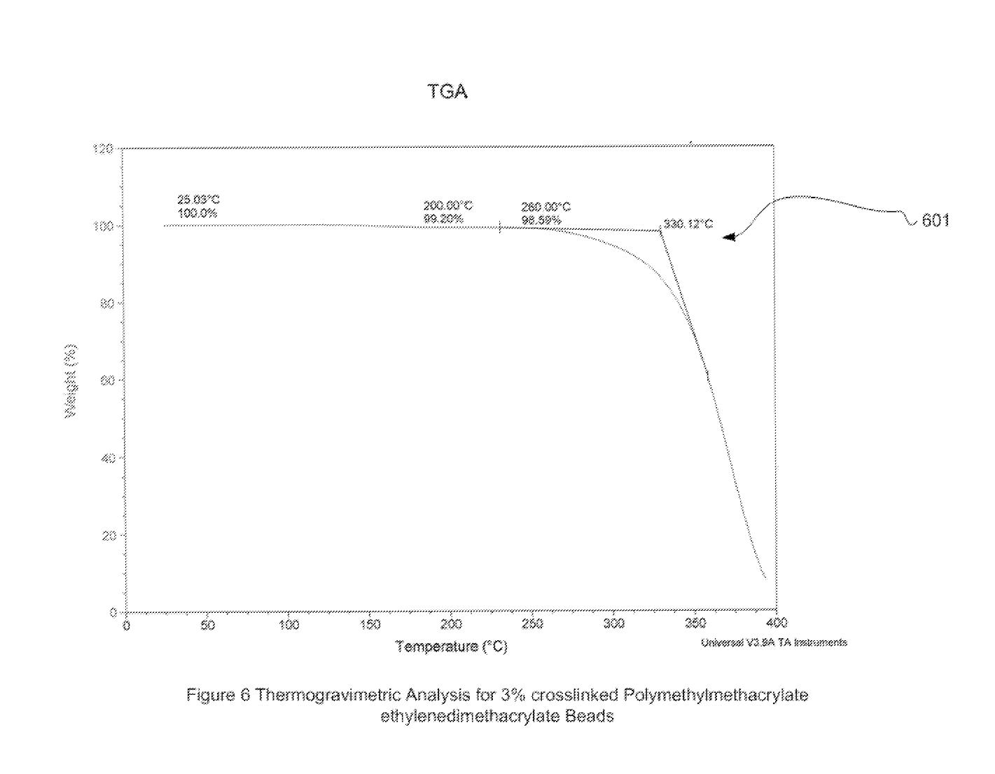

In another embodiment thermogravimetric analysis is applied to select acceptable polymethylmethacrylate beads. FIG. 5 shows thermogravimetric data for uncrosslinked polymethylmethacrylate beads. The start of decomposition is seen to occur near 260 C. (501). The results indicate that using these beads for spacer or filler particles in an adhesive used in a high temperature reflow at 260 C. would not be advisable. The decomposition temperature is too close to the required processing temperatures. Manufacturing variability in processing temperatures would likely cause failures and yield losses. In another embodiment polymethylmethacrylate beads crosslinked with ethylenedimethacrylate were used. The thermogravimetric analysis results for these beads are shown in FIG. 6. The crosslinking is seen to stabilize this polymer system against thermal decomposition up to about 330 C. (601). These beads, unlike the uncrosslinked polymethyl methacrylate beads discussed in conjunction with FIG. 5 would be suitable for high temperature applications. Summary thermogravimetric analysis data is presented in Table 1.

TABLE 1

| | Crosslink (%) | | | |
|---|---|---|---|---|
| | Or Acid Number | Weight Loss, % | | Onset |
| Material | (#) | At 200 C. | At 260 C. | Temperature C. |
| PMMA-1 | 0 | 4 | 26 | 229 |
| PMMA-2 | 0 | 11 | 31 | 220 |
| PMMA-3 | 0 | 4 | 10 | 250 |
| PMMA-4 | 8# | 0.4 | 1 | 332 |
| PMMA-5 | 3% | 1.6 | 2.2 | 325 |
| PMMA-6 | 3% | 0.8 | 1.4 | 330 |

PMMA-1, PMMA-2, and PMMA-3 are non crosslinked structures. Significant weight loss at 200 C. and at 260 C. with the onset of weight loss at 220 C. to 250 C. indicates the materials not suitable for the high temperature (above 260 C.) applications such as is required by lead-free solder reflow. PMMA-4 represents a hydrogen bond crosslinked structure and does have the thermal stability required for processing at temperatures of 265 C. and above as required for lead-free solder reflow. PMMA-5 and PMMA-6 are both PMMA samples crosslinked with ethylene dimethacrylate. Both show thermal stability characteristics suitable for use in formulations to be used at high temperature reflow conditions. Examples show that both hydrogen bond and covalently bond crosslinked samples are suitable for use in the present invention. Therefore in one embodiment of the invention material suitable for use as a spacer bead and/or filler particle is based upon the decomposition parameters for the polymer system.

In another embodiment the solubility parameters for the bead materials in the resin systems of the adhesive are tested to distinguish suitability for use. Solubility of the polymeric bead material was measured by visual observation of beads immersed in the selected resin system. Dissolution or swelling of the bead material indicated solubility sufficient to make the beads unacceptable for use as spacer or filler material. Table 2 shows solubility results for selected polymethylmethacrylate beads in exemplary resin systems.

TABLE 2

| | Solubility in these Resin Materials | | | |
|---|---|---|---|---|
| | | | diglycidyl | |
| | Isobornyl | trimethylolpropane | ether of | polypropylene |
| | Methacrylate | trimethacrylate | neopentyl | glycol-based |
| Bead Material | monomer | Monomer | glycol | epoxy resin |
| Uncrosslinked PMMA | Not soluble | Not soluble | Soluble | Not soluble |
| Acrylic acid (Hydrogen | Soluble | Soluble | Soluble | Soluble |
| Bond) cross linked | | | | |
| Polymethylmethacrylate | | | | |
| Polymethylmethacrylate | Not soluble | Not soluble | Not soluble | Not soluble |
| ethylene dimethacrylate | | | | |
| crosslinked | | | | |

Results indicate that the Uncrosslinked polymethylmethacrylate beads would not be suitable as spacer or filler material in example resins having as significant components the isobornyl methacrylate monomer, the trimethylolpropane trimethacrylate monomer or the polypropylene glycol based epoxy. It would not be eliminated based upon solubility data with the diglycidyl ether of neopentyl glycol a common reactive diluent in adhesive systems. Solubility with all major components of the resin system would be required to make a final decision as to suitability of the beads. Similarly, the acrylic acid crosslinked polymethylmethacrylate was found not to be suitable for use with any of the selected adhesive resin components whereas the polymethymethacrylate ethylenedimethacrylate crosslinked system was found to be compatible with the entire range of example resin components.

In another embodiment the combined solubility and thermal stability data is used to determine the suitability of the beads for use as spacer and filler material. The uncrosslinked polymethylmethacrylate would be suitable for all of the example resin components except the polyethylene glycol based epoxy. However as discussed above, the product was shown to not be thermally stable above 260 C. Therefore the uncrosslinked polymethylmethacrylate beads have been found suitable for use as spacer or filler material in low temperature applications, but not in the high temperatures required of led free solder reflow. In another embodiment the polymethylmethacrylate ethylene dimethacrylate crosslinked beads were found to be not soluble in all of the exemplary resin system components and also displayed high temperature stability. These cross-linked beads have been found suitable for use as filler and/or spacer material even in the high temperature applications such as required of led free solder reflow.

Table 3 shows exemplary thermal stability parameters for polystyrene based spacer beads and filler material.

TABLE 3

| | | Weight loss (%) | | Onset |
|---|---|---|---|---|
| Material | Crosslink % | At 200 C. | At 260 C. | Temperature C. |
| Polystyrene (1) | 0 | 0.6 | 0.7 | 345 |
| Polystyrene (2) | 0 | 1.4 | 1.5 | 350 |
| Polystyrene/ | 3 | 1.9 | 3.2 | 350 |
| divinylbenzene | | | | |
| (3) | | | | |
| Polystyrene/ | 55 | 2.5 | 2.9 | 340 |
| divinylbenzene | | | | |
| (4) | | | | |

Table 3 shows that there is little difference in the thermal stability properties of the cross-linked and uncrosslinked products. In fact the crosslinked products were seen to exhibit slightly higher weight loss at elevated temperatures than the uncrosslinked. Thermal stability, for this polymer system is not the selection criteria for suitability as a filler or spacer bead. Table 4 shows solubility parameters for the same set of polystyrene based materials.

TABLE 4

| | Solubility in | | | |
|---|---|---|---|---|
| | Isobornyl | Melting | | |
| | methacrylate | Temperature | Decomposition | |
| Material | resin | C. | Temperature C. | Comment |
| Polystyrene (1) | Soluble | 190 C. | >270 C. | Not |
| | | | | suitable |
| | | | | as filler |
| Polystyrene (2) | Soluble | | | Not |
| | | | | Suitable |
| | | | | as Filler |
| Polystyrene/ | Not Soluble | >270 C. | >270 C. | Suitable |
| Divinylbenzene | | | | as Filler |
| (3) | | | | |

Table 4 provides differentiation of the polystyrene based materials as to suitability as spacer beads or fillers. Those soluble in the resin system are found not suitable for filler or spacer beads and those not soluble in the resin system are found to be suitable for the purpose of a filler or spacer bead. Therefore in another embodiment of the invention the selection parameters for suitability to act as filler and/or spacer particle are based upon both the decomposition temperature and the solubility parameters of the filler in the resin system. In another embodiment of the invention decomposition properties of the proposed filler and/or spacer bead materials are a necessary, but not sufficient selection criteria.

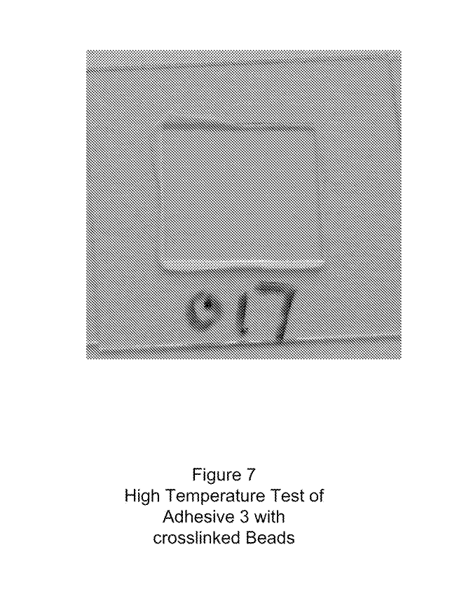

In another embodiment of the invention resin systems including the beads to be used as fillers or spacer particles are further tested in a glass slide procedure. A small aliquot of the adhesive is dispensed upon a glass microscope slide and covered with a glass cover glass under a pressure of approximately 10 N. The pressed sample is then heated to cure at a temperature of approximately 130 C. or other as required of the particular resin system of interest. The sample is then heated to a test temperature of 260 C. for 5 minutes to simulate high temperature solder reflow. The results are shown in FIG. 7. FIG. 7 shows a test sample that displayed no decomposition or void formation. A test sample prepared using a filler particle unsuitable for high temperature applications would show visible voids in the sample.

Another embodiment of the invention provides methods for adhesively attaching one article to another. Adhesive comprising a resin system and crosslinked polymeric materials are dispensed onto one surface of one or both articles. The articles are brought into intimate contact through the adhesively coated surface or surfaces, pressed together at a pressure of 1 to 50 Newtons (N), optimally approximately 10 N and cured at temperatures suitable for activation of the catalyst system, typically 100 to 300 C., for, about, 0.05 to 5 hours.

Another embodiment provides an electronic device prepared using the described adhesives. In one embodiment the device includes a circuit device and the described adhesives are used for die attachment. In another device embodiment the described adhesives are used for encapsulation. In yet another device embodiment, the device is a flip chip design that uses the adhesive to attach the chip to an interconnect means that may be either a printed circuit board or other chip interconnect devices.

### EXAMPLES

Adhesive systems were prepared with the formulations of Table 5.

TABLE 5

| | Compositions (all % are by weight) | | |
|---|---|---|---|
| Material | Adhesive 1 | Adhesive 2 | Adhesive 3 |
| Acrylate monomers | 32% | 49% | 41% |
| Cyclohexyl Maleimide | 22% | — | — |
| Soluble styrene/ | 5% | 7% | 7% |
| butadiene resin | | | |
| Soluble polybutadiene | 3% | 6% | 6% |
| maleic anhydride resin | | | |
| Soluble Polybutadiene | — | — | 8% |
| dimethacrylate resin | | | |
| Silanes | 2% | 2% | 2% |
| Peroxide catalysts | 1% | 1% | 1% |
| Crosslinked styrene | 35% | 35% | 35% |
| divinylbenzene | | | |
| microbeads | | | |

The indicated ingredients for all three adhesive systems were blended together. The resultant blends exhibited thixotropic properties, were easily dispensed using common equipment known in the art and were stable against settling out of the crosslinked microbeads. The adhesive was dispensed onto silicon dies that were pressed together with a force of 10 N and cured on a hotplate at 150 C. The resultant bonds were measured at thicknesses reflective of the diameter of the styrene divinylbenzene crosslinked microbeads. Samples were heated to 260 C. for 5 minutes to simulate lead free solder reflow. Samples were then assessed for damage. None could be detected on the intact samples. There was no indication of void formation, decomposition or delamination in the adhesive layer, between the adhesive resins and the dies, and between the adhesive resins and the microbeads.

A second set of adhesive samples were prepared with the same formulation as in Table 5 except that the crosslinked styrene divinylbenzene microbeads were replaced with polymethylmethacrylate ethyl dimethacrylate crosslinked microbeads. The prepared adhesive behaved similarly. The adhesives were thixotropic, easily dispensed using standard equipment known in the art and were stable against settling of the microbead dispersion. The adhesive was dispensed onto silicon dies that were pressed together with a force of 10 N and cured on a hotplate at 150 C. The resultant bond thickness was measured to be reflective of the diameter of the PMMA crosslinked microbeads. Samples were heated to 260 C. for 5 minutes to simulate lead free solder reflow. Samples were then assessed for damage. None could be detected on the intact samples. There was no indication of void formation, decomposition or delamination in the adhesive layer, between the adhesive resins and the dies, and between the adhesive resins and the microbeads.

### CONCLUSIONS

A new adhesive system is presented. It has been discovered that crosslinked polymeric materials may be used both as spacer particles and as filler in adhesives. The adhesives are especially useful for attaching electronic devices where controlled adhesive bond width is required and the devices make use of lead free solder or otherwise require high temperature processing. New methods for selection of suitable material to be used as spacer and filler material are presented.

I claim:

1. An adhesive composition comprising:
a) crosslinked polymeric material, and
b) a resin system comprising at least one curing catalyst and at least one polymerizable monomer selected from acrylates, vinyl ethers, epoxy resins, silane modified epoxies, amine modified epoxies, urethanes, silicones, maleimides and liquid rubber.

2. The adhesive composition of claim 1 wherein the crosslinked polymeric material is beads with mean diameters between 0.1 and 1000 microns.

3. The adhesive composition of claim 2 wherein the beads' mean diameters are between 5 and 500 microns.

4. The adhesive composition of claim 1 wherein the crosslinked polymeric material is beads with mean diameters between 0.1 microns and 15 microns.

5. The adhesive composition of claim 1 wherein the crosslinked polymeric material is ground polymeric material with mean particle diameters between 0.1 and 15 microns.

6. The adhesive composition of claim 2 wherein the beads' size distribution is bimodal with one population of beads having a mean size distribution between 15 and 500 microns and a second population of the beads having a mean size distribution between 0.1 and 15 microns.

7. The adhesive composition of claim 1 wherein the crosslinked polymeric materials comprise beads with mean diameters between 5 and 500 microns and ground crosslinked polymeric material with mean diameters between 0.1 and 15 microns.

8. The adhesive composition of claim 7 wherein the crosslinked polymeric bead material is polymethylmethacrylateethyldimethacrylate or polystyrenedivinylbenzene and the ground crosslinked polymeric material is polymethylmethacrylateethyldimethacrylate or polystyrenedivinylbenzene.

9. The adhesive composition of claim 1 wherein the crosslinked polymeric materials are polymethylmethacrylateethyldimethacrylate or polystyrenedivinylbenzene.

10. The adhesive composition of claim 1 further comprising polytetrafluoroethylene.

11. The adhesive composition of claim 1 further comprising at least one polymer selected from polymaleimides, polyurethanes, polyacrylates, styrenebutadiene copolymers, butadienedimethacrylate copolymers and polybutadiene maleic anhydride adducts, all of which are selected such that they dissolve within the other resin components.

12. The adhesive composition of claim 1 wherein the crosslinked polymeric materials are selected on the basis of thermogravimetric and solubility analyses.

13. The adhesive composition of claim 12 wherein the crosslinked polymeric materials have a decomposition temperature in excess of 260 C. and are not soluble in the resin system.

14. A method of selecting polymeric materials for use as filler and spacer particles in adhesive resins comprising:
a) thermogravimetric analysis of the polymeric materials to determine a decomposition temperature, and
b) Solubility analysis of the polymeric materials in the adhesive resin.

15. The method of claim 13 wherein the decomposition temperature for the selected polymeric materials is greater than 260 C. and the polymeric materials are not soluble in the adhesive resin.

16. A method of adhesively attaching an electronic device to a substrate each having a surface intended for adhesive attachment comprising:
a) compounding an adhesive comprised of crosslinked polymeric material, and a resin system comprising at least one curing catalyst and at least one polymerizable monomer selected from acrylates, vinyl ethers, epoxy resins, silane modified epoxies, amine modified epoxies, urethanes, silicones, maleimides and liquid rubber,
b) placing a quantity of adhesive on the adhesive intended surface of either the electronic device or the substrate or both,
c) pressing the adhesive intended surfaces together while applying heat to cure the adhesive.

17. The method of claim 16 wherein the crosslinked polymeric material is polymethylmethacrylateethyldimethacrylate or polystyrenedivinylbenzene.

18. The method of claim 16 wherein the crosslinked polymeric material is beads of mean diameter between 5 and 500 microns.

19. The method of claim 16 wherein the crosslinked polymeric material is selected by thermogravimetric analysis wherein the decomposition temperature of the crosslinked polymeric material is greater than 260 C. and by solubility analysis wherein the crosslinked polymeric material is not soluble in the resin system.

20. An assembly comprising a microelectronic device permanently adhered to a substrate by a cured aliquot of a composition comprising crosslinked polymeric material, and a resin system comprising at least one curing catalyst and at least one polymerizable monomer selected from acrylates, vinyl ethers, epoxy resins, silane modified epoxies, amine modified epoxies, urethanes, silicones, maleimides and liquid rubber.

21. The assembly of claim 20 wherein the crosslinked polymeric material is polymethylmethacrylateethyldimethacrylate or polystyrenedivinylbenzene.
